(19) United States
(12) Patent Application Publication
(10) Pub. No.: US 2010/0321370 A1
(43) Pub. Date: Dec. 23, 2010

(54) Display system and source driver thereof

(75) Inventors: Meng-Tse Weng, Tainan County (TW); Chuan-Che Lee, Tainan County (TW); Chin-Tien Chang, Tainan County (TW)

Correspondence Address: RABIN & Berdo, PC, 1101 14TH STREET, NW, SUITE 500, WASHINGTON, DC, 20005, US

(73) Assignee: HIMAX TECHNOLOGIES LIMITED, Tainan County (TW)

(21) Appl. No.: 12/457,740

(22) Filed: Jun. 19, 2009

(51) Int. Cl. G06F 3/038; G09G 3/36

(52) U.S. Cl. 345/212; 345/99

(57) ABSTRACT

A source driver includes a gamma voltage generator, in which the gamma voltage generator includes a first gamma resistor string and a second gamma resistor string. The first gamma resistor string receives a first gamma reference voltage and generates a plurality of first gamma voltages. The second gamma resistor string receives a second gamma reference voltage and generates a plurality of second gamma voltages, in which the second gamma voltages have different voltage values from the first gamma voltages. The switch circuit selects the first gamma voltages or the second gamma voltages as output gamma voltages according to a timing control signal. The digital to analog converter selects one of the output gamma voltages as a driving voltage corresponding to a received digital pixel data for driving a first pixel region or a second pixel region of the sub-pixel.

### BACKGROUND

1. Field of Invention

The present invention relates to a source driver. More particularly, the present invention relates to a source driver of a display system.

2. Description of Related Art

A liquid crystal display (LCD) is a device which displays images by controlling transmittance of incident light emitted from a light source using optical anisotropy of liquid crystal molecules and polarization characteristics of a polarizer. Recently, the application of LCD has expanded since lightweight, slim size, high resolution and large screen size can be implemented in LCD which have low power consumption.

In general, LCD have a narrow viewing angle as compared to other display devices because light is transmitted only along a light transmitting axis of liquid crystal molecules to display images. Various technologies to improve the viewing angle of an LCD have been studied. One of the technologies is aligning liquid crystal molecules perpendicular to a substrate, forming a cutout or protrusion pattern respectively on a pixel electrode and a common electrode facing the pixel electrode, in which distorting an electric field between the two electrodes forms multi-domain structure and improves the viewing angle.

Although such method shows better contrast, however, the visibility, the viewing angle, the cross talk phenomenon, and particularly the side-visibility is still unacceptable.

### SUMMARY

According to one embodiment of the present invention, a source driver is disclosed. The source driver includes a gamma voltage generator and a digital to analog converter. The gamma voltage generator includes a first gamma resistor string, a second gamma resistor string, and a switch circuit. The first gamma resistor string receives a first gamma reference voltage and generates a plurality of first gamma voltages for driving at least one first pixel region of the sub-pixel. The second gamma resistor string receives a second gamma reference voltage and generates a plurality of second gamma voltages for driving at least one second pixel region of the sub-pixel, in which the second gamma voltages have different voltage values from the first gamma voltages. The switch circuit selects the first gamma voltages or the second gamma voltages as output gamma voltages according to a timing control signal. The digital to analog converter selects one of the output gamma voltages as a driving voltage corresponding to a received digital pixel data.

According to another embodiment of the present invention, a display system is disclosed. The display system includes a display panel and a source driver. The display panel includes a plurality of sub-pixels driven by driving 20. voltages on the data lines. The source driver includes a gamma voltage generator and a digital to analog converter. The gamma voltage generator includes a first gamma resistor string, a second gamma resistor string, and a switch circuit. The first gamma resistor string receives a first gamma reference voltage and generates a plurality of first gamma voltages for driving at least one first pixel region of the sub-pixel. The second gamma resistor string receives a second gamma reference voltage and generates a plurality of second gamma voltages for driving at least one second pixel region of the sub-pixel, in which the second gamma voltages have different voltage values from the first gamma voltages. The switch circuit selects the first gamma voltages or the second gamma voltages as output gamma voltages according to a timing control signal. The digital to analog converter selects one of the output gamma voltages as a driving voltage corresponding to a received digital pixel data.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A shows the gamma voltage generator and the corresponding digital to analog converter of the source driver according to one embodiment of the present invention;

FIG. 1B shows the gamma voltage generator and the corresponding digital to analog converter of the source driver according to another embodiment of the present invention; and

FIG. 2 shows the display system according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

To improve the visibility, the viewing angle, the color shift, the cross talk phenomenon, and particularly the side-visibility of the LCD, some method such as 1 G-2 D, 1 G-1 D is utilized. These methods form a plurality of pixel regions in a sub-pixel, drive them independently, and apply different voltage to the respective divided pixel regions. Thereby, the viewing angle, the color shift, the cross talk phenomenon, and the side-visibility can be improved, since pixel regions are charged with different levels of voltage and the light transmitting axis of the liquid crystal molecule is controlled in various directions. Therefore, a gamma voltage generator is required for generating gamma voltages with different levels.

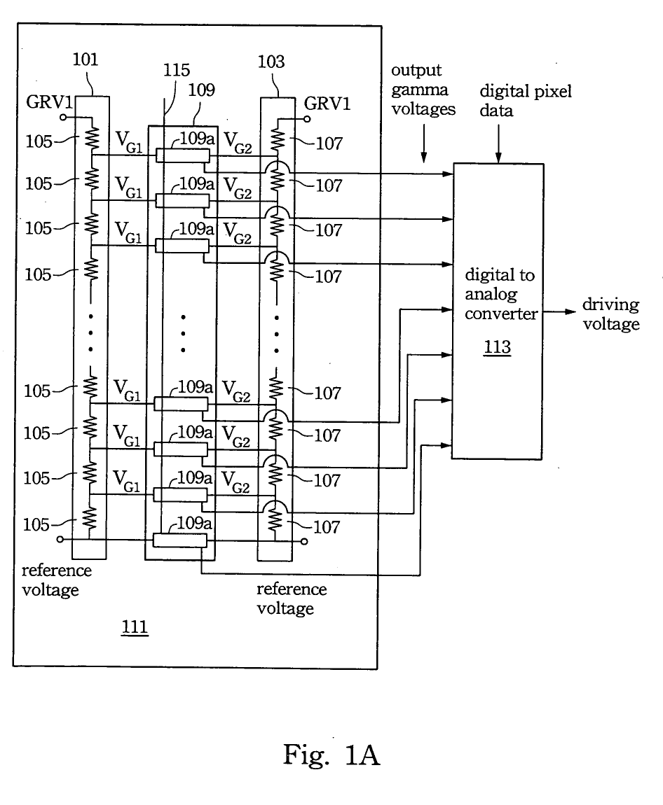

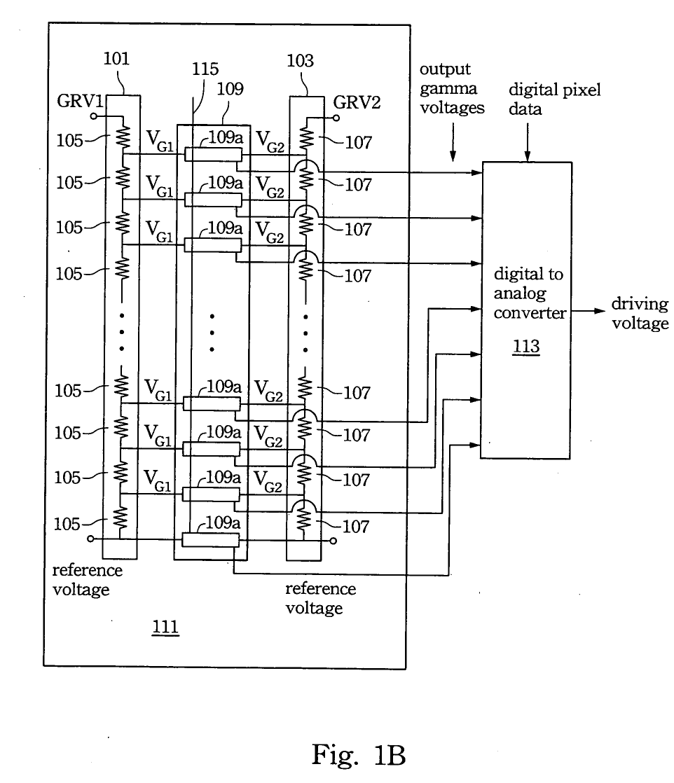

FIG. 1A shows the gamma voltage generator and the corresponding digital to analog converter of the source driver according to one embodiment of the present invention. The gamma voltage generator 111 generates gamma voltages for the digital to analog converter 113. The gamma voltage generator 111 includes a first gamma resistor string 101 and a second gamma resistor string 103.

The first gamma resistor string 101 receives a first gamma reference voltage GRV1 and generates plenty of first gamma voltages VG1 for driving at least one first pixel region of the sub-pixel, while the second gamma resistor string 103 also receives the first gamma reference voltage GRV1 and generates plenty of second gamma voltages VG2 for driving at least one second pixel region of the sub-pixel.

The first gamma resistor string 101 includes plenty of first resistors 105, and the second gamma resistor string 103 includes plenty of second resistors 107 with resistance different from those of the first resistors 105. To make the first gamma voltages VG1 have voltage levels different from the voltage levels of the second gamma voltages VG2, the serially connected first resistors 105 have resistances different from each other. For example, the serially connected first resistors 105 might have resistances such as 1Ω, 2Ω, 3Ω . . . respectively. As a result of the current flowing through the first resistors 105 and second resistors 107, the first gamma voltages VG1 and the second gamma voltages VG2 have different voltage values. The switch circuit 109 then alternatively selects the first gamma voltages VG1 or the second gamma voltages VG2 as the output gamma voltages according to the timing control signal 115. For example, the first gamma voltages VG1 are selected before the second gamma voltages are selected, that is, the switch circuit 109 first select the first gamma voltages VG1, then select the second gamma voltages VG2 sequentially.

In more detail, if the gamma reference voltage GRV1 is a 110 V and the reference voltage is 0V, on the condition that there are ten serially connected first resistors 105 with 1Ω, 2Ω, 3Ω . . . 10Ω resistance respectively, and the ten second resistors 107 all have 2Ω resistance, then the first gamma voltages VG1 are 108 V, 104 V, 98 V . . . 20V respectively, while the gamma voltages VG2 are 99 V, 88 V, 77 V . . . 11 V respectively. In other words, the first gamma voltages VG1 and the second gamma voltages VG2 have different voltage values.

The switch circuit 109, having a lot of switches 109a, selects the first gamma voltages VG1 or the second gamma voltages VG2 as output gamma voltages according to the timing control signal 115, in which all the switches 109a select the first gamma voltages VG1 or the second gamma voltage VG2 uniformly. That is, either all the switches 109a select the first gamma voltages VG1, or all the switches 109a select the second gamma voltages VG2. Then the digital to analog converter 113 selects one of the output gamma voltages as a driving voltage corresponding to the received digital pixel data. In this source driver, the number of the first gamma voltages VG1, the second gamma voltage VG2 is corresponding to the bit number of a display channel.

FIG. 1B shows the gamma voltage generator and the corresponding digital to analog converter of the source driver according to another embodiment of the present invention. In this embodiment, the first gamma resistor string 101 receives a first gamma reference voltage GRV1 and generates plenty of first gamma voltages VG1 for driving at least one first pixel region of the sub-pixel, while the second gamma resistor string 103 receives the second gamma reference voltage GRV2 having voltage different from the first gamma reference voltage GRV1, and generates plenty of second gamma voltages VG2 for driving at least one second pixel region of the sub-pixel, and the reference voltage can be 0 V in this embodiment.

The first gamma resistor string 101 includes a lot of first resistors 105 connected serially for dividing the first gamma reference voltage GRV1 into the first gamma voltages VG1, and the second gamma resistor string 103 includes a lot of second resistors 107 connected serially for dividing the second gamma reference voltage GRV2 into second gamma voltages VG2, in which the resistance of the first resistors 105 can be different from the resistance of the second resistors 107, such that the voltage value of each gamma voltage VG1 is different form the voltage value of the corresponding gamma voltage VG2. For example, the first gamma reference voltage GRV1 and the second gamma reference voltage GRV2 can be 20 V and 10V respectively, and the first resistors are 1Ω while the second resistors are 2Ω. If there are ten first resistors 105 and ten second resistors 107, as a result, the first gamma voltages are 18 V, 16 V . . . 2V, and the second gamma voltages are 9 V, 8V . . . 1V, which are different from the first gamma voltages.

On the other hand, because the second gamma reference voltage GRV2 has voltage different from the first gamma reference voltage GRV1, the resistance of the first resistors 105 can also be same to the resistance of the second resistors 107, and the voltage value of each gamma voltage VG1 is still different form the voltage value of the corresponding gamma voltage VG2.

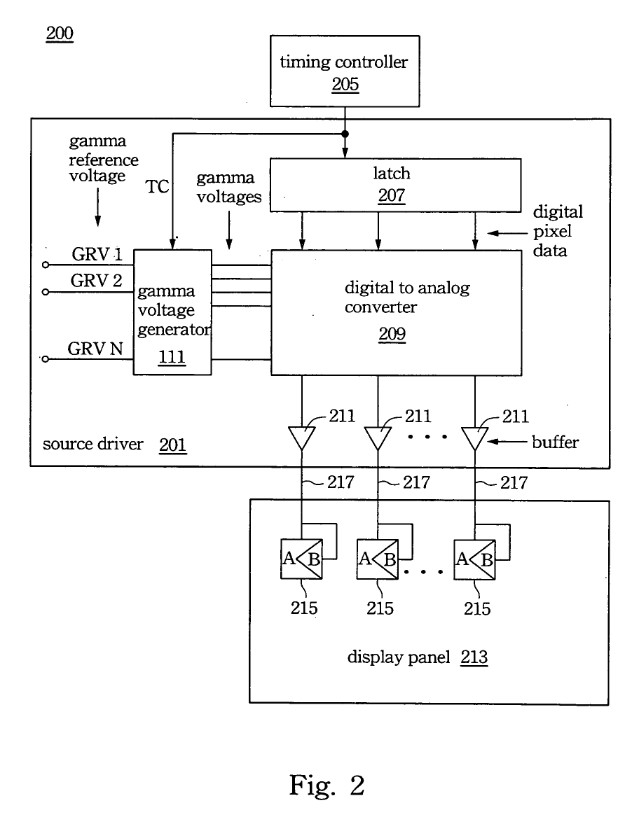

FIG. 2 shows the display system according to one embodiment of the present invention. The display system 200 includes a source driver 201, a timing controller 205 generating the digital pixel data and the timing control signal TC, and a display panel 213 having a lot of sub-pixels 215 driven by the driving voltages on data lines 217.

The source driver 201 includes the gamma voltage generator 111 and a digital to analog converter 209. The gamma voltage generator 111 generates a lot of gamma voltages according to the timing control signal TC. Then the digital to analog converter 209 selects some of the gamma voltages as the driving voltages for driving the first pixel regions A or the second pixel regions B of the sub-pixels 215 alternatively based on received digital pixel data. The source driver 201 further includes a latch circuit 207 and a buffer 211. The latch circuit 207 is electrically connected to the digital to analog converter 209, in which the latch circuit 207 stores and passes the digital pixel data for the digital to analog converter 207. The buffers 211 enhance the driving capability of the data line 217 to drive the sub-pixels 215.

The display panel 213 includes lots of sub-pixels 215 driven by driving voltages on data lines 217. The sub-pixels 213 can be red light sub-pixels, green light sub-pixels, or blue light sub-pixels. The sub-pixels 215 of the display panel 213 include a lot of first pixel regions A driven by the driving voltages corresponding to the first gamma voltages, and a lot of second pixel regions B driven by the driving voltages corresponding to the second gamma voltages. Therefore, the pixel region A and the pixel region B of each sub-pixel 215 can be driven by voltage with different voltage value alternatively, which improves the visibility, particularly the side-visibility of the LCD.

According to the above embodiment, each of the sub-pixels is divided as at least two pixel regions, and the source driver can drive the pixel regions with different voltages alternatively according to the timing control signal, which improves the visibility, particularly the side-visibility of the LCD.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A source driver, comprising:
a gamma voltage generator, comprising:
a first gamma resistor string receiving a first gamma reference voltage and generating a plurality of first gamma voltages for driving at least one first pixel region of the sub-pixel;
a second gamma resistor string receiving a second gamma reference voltage and generating a plurality of second gamma voltages for driving at least one second pixel region of the sub-pixel, wherein the voltage values of the second gamma voltages are different from the voltage values of the first gamma voltages; and
a switch circuit selecting the first gamma voltages or the second gamma voltages as output gamma voltages according to a timing control signal; and
a digital to analog converter selecting one of the output gamma voltages as a driving voltage corresponding to a received digital pixel data.

2. The source driver as claimed in claim 1, wherein the number of the first gamma voltages or the second gamma voltage is corresponding to the bit number of a display channel.

3. The source driver as claimed in claim 1, wherein the voltage value of the first gamma reference voltage is different from the voltage value of the second gamma reference voltage, such that the voltage values of the first gamma voltages are different from the voltage values of the second gamma voltages.

4. The source driver as claimed in claim 3, wherein the first gamma resistor string comprises a plurality of first resistors connected serially for generating the first gamma voltages with different voltage values, and the second gamma resistor string comprises a plurality of second resistors connected serially for generating the second gamma voltages of different voltage values.

5. The source driver as claimed in claim 4, wherein the first resistors have the same resistance.

6. The source driver as claimed in claim 5, wherein the resistance of the second resistors is different from the resistance of the first resistors.

7. The source driver as claimed in claim 1, wherein the first gamma resistor string comprises a plurality of first resistors for dividing the first gamma reference voltage, and the second gamma resistor string comprises a plurality of second resistors for dividing the second gamma reference voltage, in which the voltage values of the first gamma reference voltage and the second gamma reference voltage are the same.

8. The source driver as claimed in claim 7, wherein the serially connected first resistors have different resistances.

9. The source driver as claimed in claim 1, wherein the switch circuit alternatively selects the first gamma voltages or the second gamma voltages as the output gamma voltages, and the first gamma voltages are selected before the second gamma voltages are selected.

10. The source driver as claimed in claim 1, further comprises a latch circuit electrically connected to the digital to analog converter, wherein the latch circuit stores and passes the digital pixel data for the digital to analog converter.

11. The source driver as claimed in claim 1, further comprises a buffer for enhancing the driving capability to drive the sub-pixel.

12. The source driver as claimed in claim 1, wherein the driving voltage drives a first pixel region or a second pixel region of the sub-pixel alternatively.

13. A display system, comprising:
a display panel comprising a plurality of sub-pixels driven by driving voltages on data lines; and
a source driver, comprising:
a gamma voltage generator, comprising:
a first gamma resistor string receiving a first gamma reference voltage and generating a plurality of first gamma voltages for driving first pixel regions of the sub-pixels;
a second gamma resistor string receiving a second gamma reference voltage and generating a plurality of second gamma voltages for driving second pixel regions of the sub-pixels, wherein the voltage values of the second gamma voltages are different form the voltage values of the first gamma voltages; and
a switch circuit selecting the first gamma voltages or the second gamma voltages as output gamma voltages according to a timing control signal; and
a digital to analog converter selecting some of the output gamma voltages as the driving voltages based on received digital pixel data.

14. The display system as claimed in claim 13, wherein the sub-pixels comprises:
a plurality of first pixel regions driven by the driving voltages corresponding to the first gamma voltages; and
a plurality of second pixel regions driven by the driving voltages corresponding to the second gamma voltages.

15. The display system as claimed in claim 14, wherein the sub-pixels are red light sub-pixels, green light sub-pixels, or blue light sub-pixels.

16. The display system as claimed in claim 13, further comprising a timing controller generating the digital pixel data latched by the latch circuit.

17. The display system as claimed in claim 16, wherein the timing controller further generates the timing control signal selecting the first gamma voltages or the second gamma for the digital to analog converter.

18. The display system as claimed in claim 13, wherein the first gamma resistor string comprises a plurality of serially connected first resistors having the same resistance, and the voltage value of the first gamma reference voltage is different from the voltage value of the second gamma reference voltage, such that the voltage values of the first gamma voltages from the first resistors are different from the voltage values of the second gamma voltages from the second resistors.

19. The display system as claimed in claim 13, wherein the first gamma resistor string comprises a plurality of serially connected first resistors of various resistances for dividing the first gamma reference voltage, and the second gamma resistor string comprises a plurality of second resistors for dividing the second gamma reference voltage, in which the voltage values of the first gamma reference voltage and the second gamma reference voltage are the same.
